(19) United States
(12) Patent Application Publication
(10) Pub. No.: US 2018/0053348 A1
(43) Pub. Date: Feb. 22, 2018

(54) VOLITION AND VISUAL ENHANCING PROCESSES EMBEDDED IN WEARABLE DEVICE

(71) Applicant: PABLO ENRIQUE CONTRERAS GUTIERREZ, BALLAJURA (AU)

(72) Inventor: PABLO ENRIQUE CONTRERAS GUTIERREZ, BALLAJURA (AU)

(21) Appl. No.: 15/237,932

(22) Filed: Aug. 16, 2016

(51) Int. Cl. G06T 19/00; H04L 29/08; G06F 3/01; H04N 5/225

(52) U.S. Cl. CPC G06T 19/003; H04N 5/225; G06F 3/013; H04L 67/02

(57) ABSTRACT

The interaction of human functions and internet data assisted by a wearable computational device that allows direct volition manifestation over internet links on offer employing eye tracking web navigation technology is a brain empowering revolution. A wearable computational device that incorporates a video camera that feeds life video of our surroundings back to the user of this device has resolved the natural human limitation to multitask while on the move. Brainpower as never conceptualized before.

### CROSS REFERENCE

NA

### STATEMENT OF SPONSORED RESEARCH

NA

### NAMES OF PARTIES TO JOINT RESEARCH

NA

### REFERENCE TO LISTINGS OR TABLE

NA

### BACKGROUND OF INVENTION

A solid non-transparent object placed in front of the human eyes impairs seeing capabilities.

A person that wears a solid non-transparent object right in front of the eyes and is capable of making sense of what lays in front of the object would be a novel development.

This novel development rendered possible by the amalgamation of different products currently in the market is the basis of this patent application.

The reasoning behind the analytical conclusion of its possibility is nonobvious and counterintuitive.

### BRIEF SUMMARY OF THE INVENTION

New Process of Visual Perception: To see, assisted exclusively by a video camera incorporated in a wearable computational device that is between the user eyes and what is in front the user and where the real time video feed of the users path is being played within the background of 3d imagery is the remit of this patent application.

The process of perception related to the sight sense is altered/improved when a device that embeds this process is used. When the device is worn the object(s) or sight observed have never been observed in the same manner.

New Process of Volition Manifestation: To command an Internet link assisted by a wearable device that receives directly the command by eye movement detection is the remit of this patent application.

The process of manifestation of volition is altered/improved when a device that embeds this process is used. When the device is worn, devices with Internet connection or Internet links have never been subject to be affected or action by the brain through the eye in the same manner.

The combination of devices elements and functions embedded in the wearable computational device make the conceptualization of these new processes possible.

### BRIEF DESCRIPTION OF THE SEVERAL VIEWS OF THE DRAWINGS

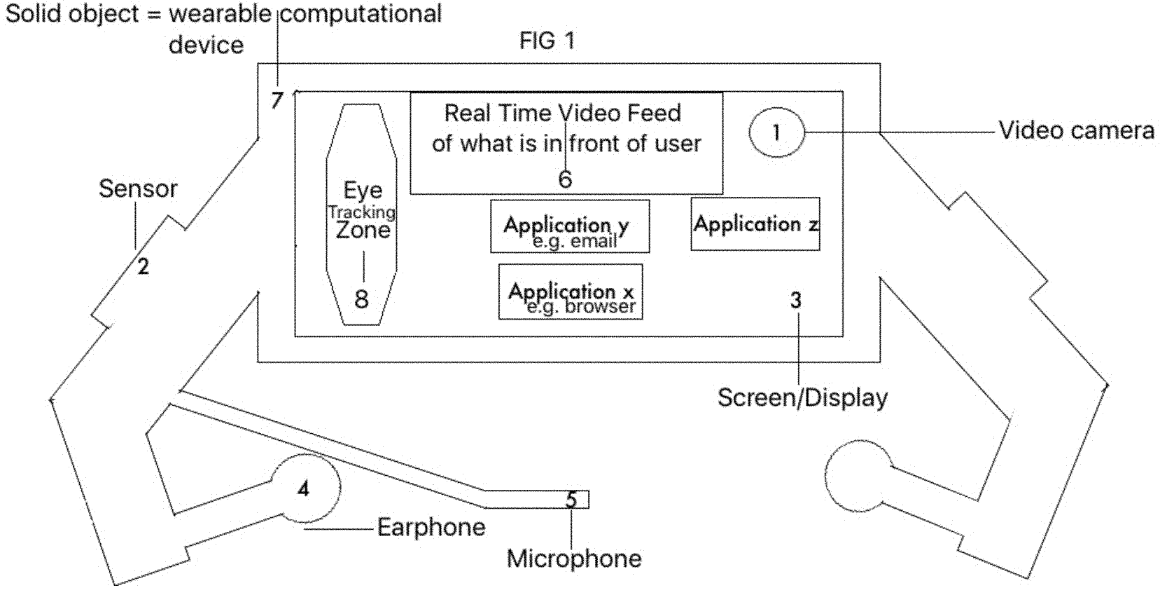

8.1—Graphical Description of FIG. 1—

The rectangular shape portrays the wearable device as viewed by the user when mounted on the nose. The right and left lines portray the arms leaning down that are to be held by user's ears. The numbers inside the solid lines name each part of the device as follows.

Volition and Visual Enhancing Processes Embedded in Wearable Device
1. Video Camera
2. Sensor
3. Screen/Display
4. Earphone
5. Microphone
6. Real time video feed of what is in front of user
7. Solid Object=Wearable computational device battery powered with operative system and microprocessor that perform the functions of such devices.
8. Eye tracking zone.

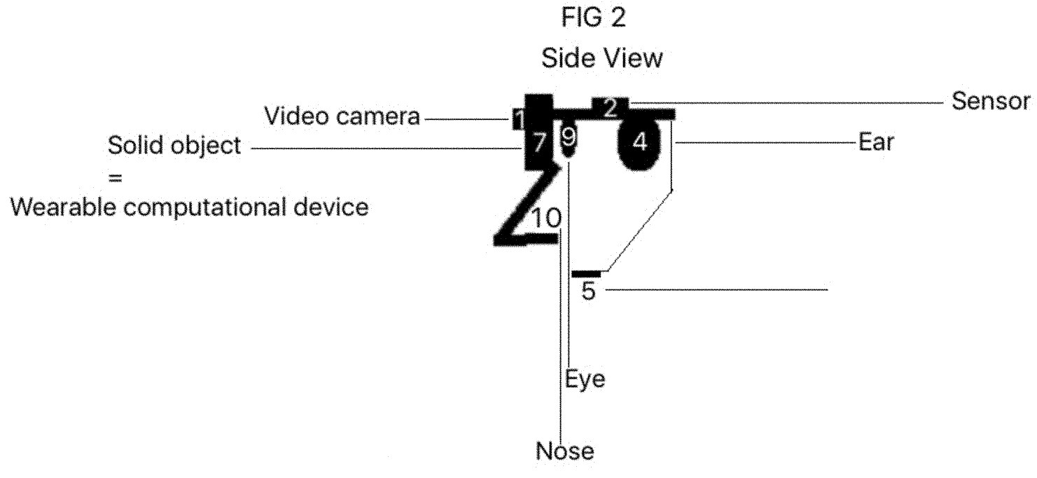

8.2—Graphical Description of FIG. 2—

The wearable device is portrayed being worn by user as viewed by a second person on the left of the user of the device. The numbers below the heading Side View name some user's body parts and some parts of the device as above and below.

Side View of 8.1 (Read in Conjunction with 8.1)
9. Eye
10. Nose

### DRAWINGS PURPOSE

The drawings are for description only purposes. The processes the subject of this patent application are embedded in a device. The device can take a helmet shape, headset shape and various other forms.

### DETAILED DESCRIPTION OF IMPROVED PROCESSES OF VISUAL PERCEPTION AND VOLITION MANIFESTATION

The sight sense is initially blocked with the solid object wearable computational device embedding the new processes 7. This blockage is then lifted and exponential improved by a resource 1. The resource is a video camera 1 able to clearly bring imagery placed near and faraway from the user. The solid object holds in addition navigation sensors 2 that alert the user of the nearness of objects.

The solid object is a computational device and as such runs on batteries, has memory, performs analytical functions with a microprocessor, has a display 3 where different applications have their graphic representation and shares this space with the real-time video feed 6 the video camera captures. The video feed is played real-time in the background of 3d environment imagery. Example: a 3d game, film or interactive wallpaper is playing on its dedicated section of the screen. The real time-video feed of the user's surroundings is being played within this game or film rendering this devise user friendly. The real-time feed is visualized by its direct representation on the display and/or deconstructed visual representations of functions of this feed.

The navigation within and between applications is conducted through eye tracking 8 technology (cornea/iris movement detection). The eye directly actives the opening and closing starting or stopping any device connected to the Internet. The eye is the human organ that directly activates or actions Internet links on this wearable computational device 7.

A cursor that follows the lead of mousse-like/joysticks held on left and/or right hand support navigation/interaction further more.

Wearing this device empowers the user substantially. Its sight and brain are permanently interconnected with data received/linked by/to this wearable computational device 7.

Being able to see our surroundings and at the same time perform analytical functions and manifest our volition over any Internet link assisted by a wearable computational device is a revolutionary development.

Technological advances make possible the reasoning behind this invention.

The elements that make the compact of the Volition and Visual Enhancing Processes Embedded in Wearable Device are market products. The Volition and Visual Enhancing Processes Embedded in Wearable Device manufacture incorporates and costs all proprietary components, processes, their patents and copyrights; affording pecuniary rights to whom they should belong. When appropriate and viable in-house developed components are employed.

1- This patent application seeks to exclude the commercialization and manufacture of any wearable device that embeds the process that would allow the human eye to see the world and its components not directly by the bare eye but exclusively through a real time video feed played into a wearable device that fits the above, below and drawings description.

2- This patent application seeks to exclude the commercialization and manufacture of any wearable device that embeds the process that would allow the human brain to impart an order through an internet link accessed by eye tracking detection technology that would activate or modify any device with internet connection and/or activate the options provided by such or similar internet links through a wearable device that fits the above, below and drawings description.
